(19) United States
(12) Patent Application Publication
(10) Pub. No.: US 2007/0098207 A1
(43) Pub. Date: May 3, 2007

(54) STRUCTURE OF RIBBON TYPE PLANAR SPEAKER

(75) Inventor: Chen-Ron Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: BESTON TECHNOLOGY CORPORATION, Taipei (TW)

(21) Appl. No.: 11/470,259

(22) Filed: Sep. 6, 2006

(30) Foreign Application Priority Data
Nov. 2, 2005 (TW) 94218898

(51) Int. Cl. H04R 9/06

(52) U.S. Cl. 381/399; 381/396

(57) ABSTRACT

A structure of ribbon type planar speaker is provided, which includes a composite diaphragm with a flexible edge fixed on a fixed end; a first magnet and a second magnet, respectively disposed above and below the composite diaphragm, and respectively fixed on an upper frame and a lower frame, wherein both frames have openings; and a second lower frame, disposed below the lower frame, wherein an air damping absorption layer is disposed between the lower frame and the second lower frame. The air damping absorption layer enhances air damping and thus limits irregular vibration between the diaphragm and the pushed air. Therefore, when the diaphragm of the ribbon type planar speaker is in vibration, the effective vibration range performs uniform synchronous vibration, thus making the frequency response range broader and smoother.

### CROSS-REFERENCE TO RELATED APPLICATION

This application claims the priority benefit of Taiwan application serial no. 94218898, filed Nov. 2, 2005. All disclosure of the Taiwan application is incorporated herein by reference.

### BACKGROUND OF THE INVENTION

1. Field of Invention

The present invention relates to a structure of a ribbon type planar speaker.

2. Description of Related Art

The ribbon type planar speaker has been used and developed for quite a long time. U.S. patents No. 4,273,968, No. 4,480,155, No. 6,104,825, No. 4,471,173 and No. 5,021,613 disclose the structure and related content of the ribbon type planar speaker. The structure of an ordinary ribbon type planar speaker is shown in FIG. 1, wherein a metal conductor 14 is directly molded on an insulating thin film 15, thus forming a diaphragm with an electric circuit. When current signals are led to the speaker, the current that passes through the electric circuit of the diaphragm and the magnetic field of a magnet 11 on the ribbon type planar speaker generate an electromagnetic applied force, such that the diaphragm vibrates and pushes air to make sounds, i.e., converting electric energy into sound energy.

Different from an ordinary moving-coil loudspeaker, the electric circuit of the diaphragm of the ribbon type planar speaker has the function of a voice coil which can drive the diaphragm to vibrate. However, the diaphragm of an ordinary moving-coil loudspeaker must be connected with a voice coil and makes sounds via the vibration of the voice coil. As the diaphragm of the ribbon type planar speaker is thin and light, the vibration system thereof is lighter than that of an ordinary moving-coil loudspeaker, and thus the sensitivity of the ribbon type planar speaker is higher.

Referring to FIG. 2, it is a structure of another ordinary ribbon type planar speaker. Bar magnets 21, 22 parallel to the direction of the electric circuit are disposed on both upper and lower sides or either of the above two sides of a diaphragm 25. The bar magnets 21, 22 are symmetrically disposed on the upper and lower sides of the diaphragm 25, such that the magnetic fields on both sides of the diaphragm are symmetric, thus achieving a wide linear dynamic range and a high sensitivity.

The ribbon type planar speaker and the moving-coil loudspeaker both can use the piston motion manner together with the infinite baffle board condition to explain characteristics of the output audio frequency when the vibration system of the speaker vibrates under the electromagnetic force. Referring to Chapter 8, the third edition of “Fundamentals of Acoustics” by Lawrence E. Kinsler, the relationship between the far field sound pressure generated right in front of the speaker and the frequency, equivalent radius of the speaker diaphragm and distance is as follows.
Sound pressure p=(√2*π²*ρ₀*a²*f²*ξ)/r
wherein, π is circumference ratio, ρ₀ is air density, a is equivalent radius of the speaker diaphragm during the piston motion, f is vibration frequency, ξ is the amplitude of vibration of the diaphragm during the piston motion, and r is the distance between the test point and the speaker.

Therefore, under the same diaphragm area and testing distance, the sound pressure is in direct ratio with the square of the frequency and the first power of the amplitude. To generate the same sound pressure, the diaphragm requires a small amplitude at a high frequency; on the contrary, the diaphragm requires a large amplitude at a low frequency. The low frequency response of the ribbon type planar speaker is poor unless the area of the diaphragm is enlarged.

### SUMMARY OF THE INVENTION

According to one aspect of the present invention, a structure of the ribbon type planar speaker is provided, which comprises a composite diaphragm with a flexible edge fixed on a fixed end; a first magnet and a second magnet, respectively disposed above and below the composite diaphragm, and respectively fixed on an upper frame and a lower frame, wherein both of the upper frame and the lower frame have openings; and a second lower frame, disposed below the lower frame, wherein an air damping absorption layer is disposed between the lower frame and the second lower frame.

According to another aspect of the present invention, a structure of the ribbon type planar speaker is provided, wherein the composite diaphragm of the ribbon type planar speaker is of a spatial structure, so as to enhance the rigidity of the composite diaphragm. As such, the composite diaphragm is still approximately in a piston motion with a large amplitude, thus reducing the low frequency distortion.

Other advantages and details of the present invention will be further illustrated below by embodiments.

### BRIEF DESCRIPTION OF THE DRAWINGS

FIG. 1 is a schematic view of a conventional rectangular ribbon type planar speaker.

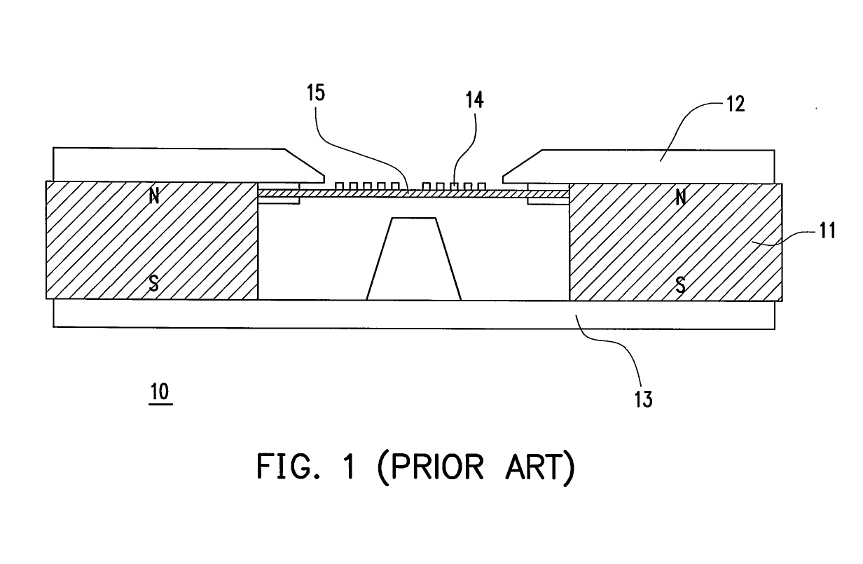

FIG. 2 is a schematic view of another conventional ribbon type planar speaker.

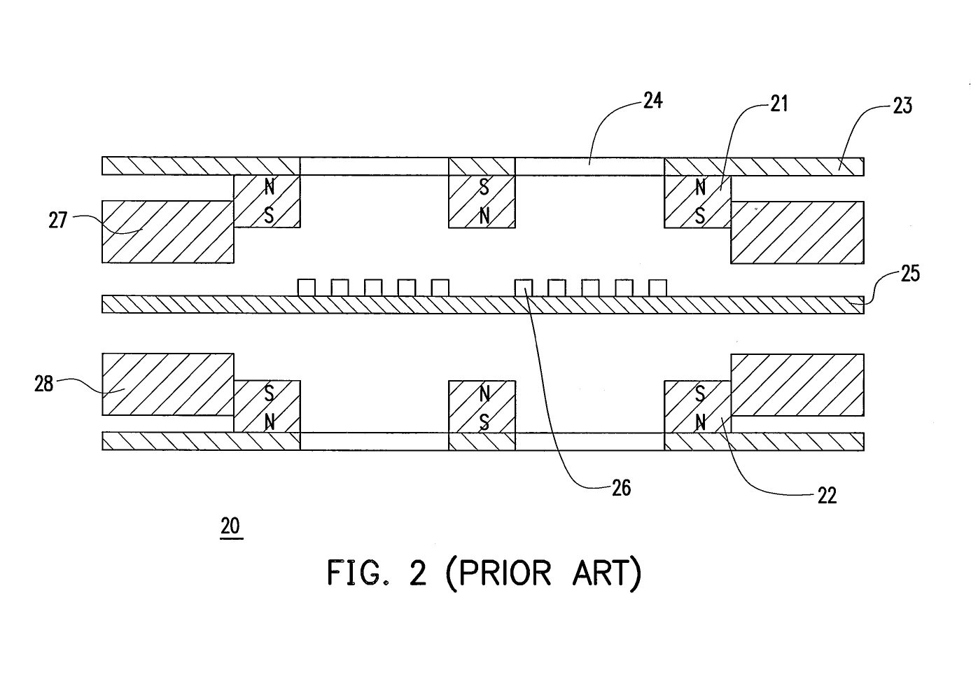

FIG. 3 is a schematic view of the ribbon type planar speaker according to an embodiment of the present invention.

FIG. 4 is a top view of the composite diaphragm according to an embodiment of the present invention.

### DESCRIPTION OF EMBODIMENTS

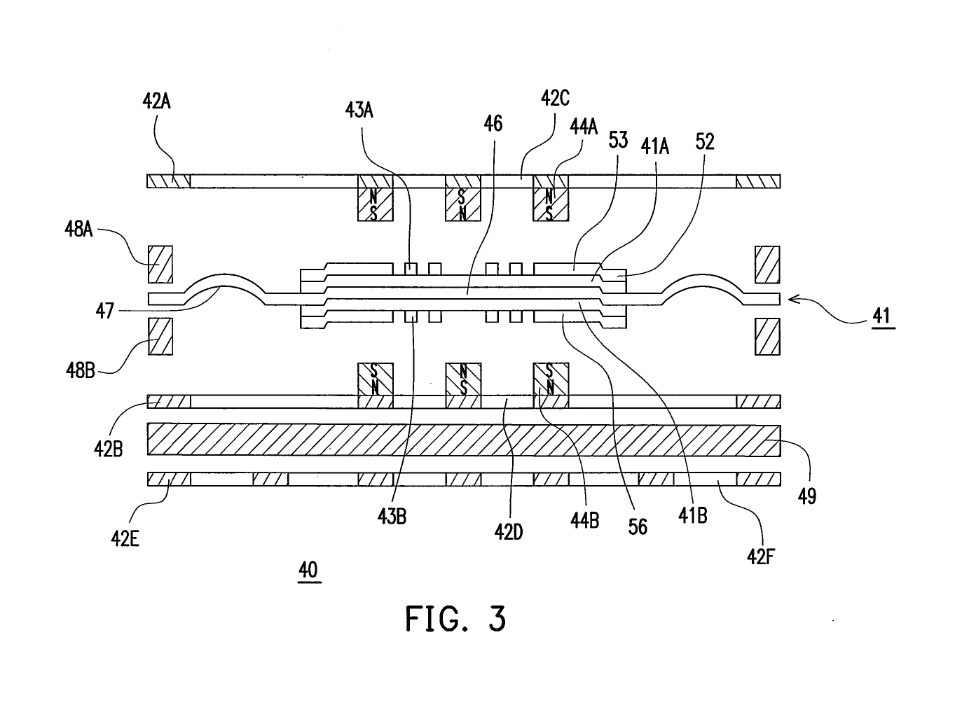

Referring to FIG. 3, it is a sectional view of the ribbon type planar speaker according to an embodiment of the present invention. A one-piece integrated composite diaphragm 41 of the speaker comprises an upper ribbon type diaphragm, a planar reinforcement structure 46 and a lower ribbon type diaphragm. The upper ribbon type diaphragm comprises an upper insulating layer 41A and a metal electrode circuit 43A above the upper insulating layer. The lower ribbon type diaphragm comprises a low insulating layer 41B and a metal electrode circuit 43B below the lower insulating layer. The planar reinforcement structure 46 further comprises a flexible edge structure 47 fixed on a fixed end 48A and a fixed end 48B. In the present embodiment, the fixed end 48A is disposed on an upper frame 42A and the fixed end 48B is disposed on a lower frame 42B. In the present embodiment, the upper ribbon type diaphragm and the lower ribbon type diaphragm are double-layer composite metal thin films formed by metal foils 43A, 43B and polymer insulating layers 41A, 41B. The double-layer composite metal thin film is fabricated by coating the metal foil with the polyamic acid resin solution and then drying by baking. However, the metal layer can also be formed on the polyimide resin thin film by physical vapor deposition or chemical electroplating. As the double-layer composite metal thin film does not have an adhesive layer as buffer layer, the thermal expansion coefficients of the metal layers 43A, 43B and polymer insulating layers 41A, 41B had better be the same, so as to prevent the composite metal thin film being curled and the interlaminar stress due to the thermal expansion difference.

The planar reinforcement structure 46 with the flexible edge structure 47 is fabricated as follows. After Nomex temperature-resistant fiber paper (from DuPont Company, model: Nomex 411) and impregnated epoxy resin/MEK (methyl-ethyl ketone) solution (Taiwan Kinmen Chemical Industry No. AS1032 single-fluid epoxy resin product) become B-stage epoxy resin pre-preg, the upper and lower ribbon type diaphragms are respectively disposed above or below the one-piece integrated flat plate structure 46 and the conductor circuits 43A, 43B of the ribbon type diaphragm have one side facing outside. After that, the composite diaphragm structure 41 with a flexible edge is formed by performing thermal compression molding in a thermal compression mould (not shown).

The planar reinforcement structure 46 with the flexible edge structure 47 is made of impregnated fiber, Nomex temperature-resistant fiber paper (from DuPont, model: Nomex 411), or an ordinary cone paper material, such as ordinary cotton/hemp couched cone paper, cotton cloth, synthetic fiber textile such as synthetic paper or cloth made of Conex fiber from Japan Teijin Company or Kevlar fiber from America DuPont Company, or synthetic paper or cloth blended by the above fibers, or even metal thin films. The key point is that the material must be thin, light and can provide reinforcement to the structure of the composite metal thin film, thus achieving the advantages of lightness and sensitivity.

The upper and lower ribbon type diaphragms can also be three-layer composite metal thin films clad by metal foils, adhesive layers (not shown) and polymer film layers. The metal foil can be an aluminum foil, aluminum alloy foil or composite metal foil clad by aluminum and other metals, and the thickness thereof had better be smaller than 35 μm. The adhesive layer can be an acrylic resin, epoxy resin or polyimide film layer and the thickness thereof is smaller than 10 μm. The polymer film layer can be polyester adhesive layer such as Mylar thin film produced by America DuPont Company, polyimide resin thin film such as Kapton thin film produced by DuPont Company or PEI plastic thin film produced by America GE, PEN plastic thin film produced by America DuPont Company or other temperature-resistant plastic thin films.

Bar magnets 44A and 44B are respectively disposed above and below the composite diaphragm 41 and are respectively fixed on the upper frame 42A and the lower frame 42B. The longitudinal axis direction of the bar magnet 44A is perpendicular to the drawing sheet and is parallel to the current direction on the metal electrode circuit 43A underneath the bar magnet 44A. The symbols N and S on the bar magnet 44A represent that the magnetizing direction thereof is parallel to the drawing sheet, wherein the upper side is S pole and the lower side is N pole. The bar magnet 44A is fixed on the upper frame 42A of the ribbon type planar speaker. The external sides of the flexible edge structure 47 of the composite diaphragm 41 are fixed by the fixed ends 48A and 48B, thus fixing the composite diaphragm 41 between the upper frame 42A and the lower frame 42B. When the composite diaphragm 41 vibrates, sound can be transmitted out from openings 42C in the upper frame 42A and openings 42D in the lower frame 42B simultaneously.

A second lower frame 42E is further disposed underneath the lower frame 42B. A filled air permeable air damping absorption layer 49 is in the space between the lower frame 42B and the second lower frame 42E, which can be an air permeable sound absorption material made of various wool, natural cotton, paper pulp fiber, glass fiber, foam, synthetic fiber and so on. The filled air permeable air damping absorption layer can also be disposed at the external sides of the upper frame 42A and the lower frame 42B or at either side. The quantity, size and disposing position of the bar magnets 44A, 44B or only disposing the bar magnets either above or below the composite diaphragm 41 can all be appropriately adjusted according to the demands of generating the sound pressure. The spaces above/below the composite diaphragm 41 and inside the ribbon type planar speaker can be filled by sound absorption and damping materials such as various wool, natural cotton, glass fiber and synthetic fiber, so as to reduce unnecessary sound reflection and vibration. The surfaces of the flexible edge structure 47 and the composite diaphragm 41 can also be coated with damping glue to enhance the damping of the flexible edge. The damping glue can be acrylic resin, epoxy resin, polyurethane, silicone or other soft polymer adhesive materials.

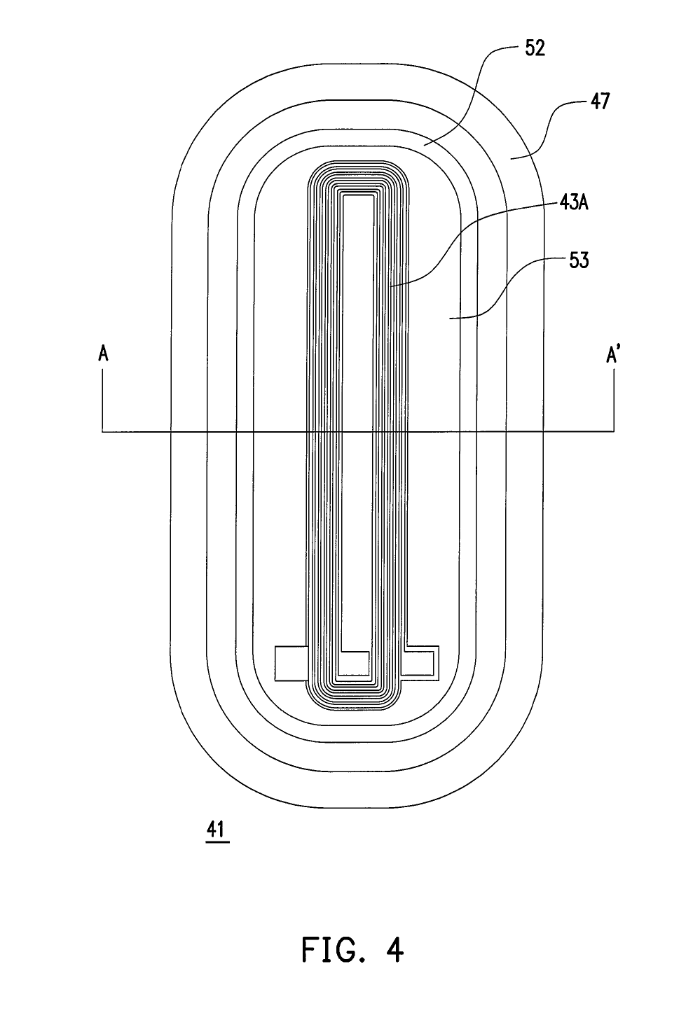

Referring to FIG. 4, it is a top view of the composite diaphragm structure 41. As an ordinary planar composite diaphragm is of a planar thin structure and the rigidity in the direction perpendicular to the diaphragm plane is very weak, the planar composite diaphragm is easily deformed and it is easy to cause irregular splitting vibration under a big stroke. In the present embodiment, the ordinary planar composite diaphragm is replaced by a spatial composite diaphragm, wherein the spatial diaphragm is formed by compression molding during the composite thermal compression molding or after the planar composite diaphragm is fabricated. Perform plastic deformation to an upper metal electrode layer 53 and a lower metal electrode layer 56 of the compressed composite diaphragm 41, such that the planar structure is changed into a spatial structure of a compressed plastic deformation region 52 with a composite diaphragm. Therefore, the whole composite diaphragm 41 comprising metal foils 43A, 43B and polymer insulating layers 41A, 41B is approximately of a “ [symbol] ”-shaped spatial structure, thus enhancing the rigidity of the composite diaphragm in the direction perpendicularly to the diaphragm plane. In view of the above, the air damping is increased due to the set of the air damping absorption layer 49, thereby limiting the irregular vibration between the diaphragm and the pushed air. As such, when the ribbon type planar speaker diaphragm is in vibration, the effective vibration region performs uniform synchronous vibration, thus making the frequency response region broader and smoother. Moreover, as the composite diaphragm is formed by compression molding during the composite thermal compression molding, the rigidity of the composite diaphragm perpendicularly to the direction of the diaphragm plane is enhanced and the diaphragm is still approximately in a piston motion with a large amplitude, thus reducing the diaphragm deformation and distortion caused by splitting vibration. Though the present invention is illustrated by the above embodiments, they do not mean that the protecting region of the present invention is limited by the above illustration. For those skilled in the art, various modifications can be made, for example, altering the vibration-absorption materials or magnet conducting materials, altering the shape of the conducting layer on the diaphragm, changing the metal layers into other conducting layers, changing the direction of the components without changing their relative positions, changing the shapes of the magnets and the magnet conducing components or even changing the magnets at both sides of the composite diaphragm into at one side, so as to achieve the same function. However, all those changes must not depart from the spirit of the present invention and still fall in the protecting range of the present invention. Moreover, the protecting range of the present invention falls in the appended claims.

What is claimed is:

1. A structure of ribbon type planar speaker, comprising:
a composite diaphragm of ribbon type planar speaker, having a flexible edge fixed on a fixed end;
a first magnet and a second magnet, respectively disposed above and below the composite diaphragm, and respectively fixed on an upper frame and a lower frame, wherein the upper frame and the lower frame have openings;
a second lower frame, disposed below the lower frame, wherein an air damping absorption layer is disposed between the lower frame and the second lower frame.

2. The structure of ribbon type planar speaker according to claim 1, wherein the air damping absorption layer is an air permeable air damping absorption layer.

3. The structure of ribbon type planar speaker according to claim 2, wherein the air permeable air damping absorption layer is at least one selected from among wool, natural cotton, paper pulp fiber, glass fiber, foam and synthetic fiber.

4. The structure of ribbon type planar speaker according to claim 1, wherein the composite diaphragm comprises a metal layer in the form of a conductor circuit, a polymer insulating layer and a planar reinforcement structure made of impregnated resin fiber.

5. The structure of ribbon type planar speaker according to claim 4, wherein a glue layer is disposed between the polymer insulating layer of the composite metal thin film and the one-piece integrated planar reinforcement structure.

6. The structure of ribbon type planar speaker according to claim 5, wherein the glue layer is one selected from the group consisting of phenolic resin, acrylic resin, epoxy resin, and polyimide.

7. A structure of ribbon type planar speaker, comprising:
a first composite thin film, formed by disposing a first conductor circuit on a first insulating layer;
a second composite thin film, formed by disposing a second conductor circuit on a second insulating layer;
a one-piece integrated planar reinforcement structure, having a flexible edge, and made of impregnated fiber;
both sides of the one-piece integrated planar reinforcement structure being respectively integrated with one side of the first insulating layer of the first composite thin film and one side of the second insulating layer of the second composite thin film, so as to form the composite diaphragm of the ribbon type planar speaker;
an upper frame and a lower frame, respectively disposed above and below the composite diaphragm, wherein the upper frame and the lower frame have openings;
a second lower frame, disposed below the lower frame, wherein an air damping absorption layer is disposed between the lower frame and the second lower frame.

8. The structure of ribbon type planar speaker according to claim 7, further comprising a first magnet and a second magnet, respectively disposed above and below the composite diaphragm and respectively fixed on the upper frame and the lower frame.

9. The structure of ribbon type planar speaker according to claim 7, wherein a first glue layer is disposed between the first insulating layer of the first composite thin film and the one-piece integrated planar reinforcement structure, and a second glue layer is disposed between the second insulating layer of the second composite thin film and the one-piece integrated planar reinforcement structure.

10. The structure of ribbon type planar speaker according to claim 7, wherein a first polymer adhesive layer is disposed between the first conductor circuit and the first insulating layer, and a second polymer adhesive layer is disposed between the second conductor circuit and the second insulating layer.

11. The structure of ribbon type planar speaker according to claim 10, wherein the thickness of the first polymer adhesive layer and the thickness of the second polymer adhesive layer are both lower than 10 μm.

12. The structure of ribbon type planar speaker according to claim 7, wherein the first magnet and the second magnet are bar magnets.

13. The structure of ribbon type planar speaker according to claim 7, wherein the first magnet and the second magnet are respectively parallel to the current direction on the first conductor circuit and the second conductor circuit.

14. A structure of ribbon type planar speaker, comprising:
a first composite thin film, formed by disposing a first conductor circuit on a first insulating layer;
a second composite thin film, formed by disposing a second conductor circuit on a second insulating layer;
a one-piece integrated planar reinforcement structure, having a flexible edge, and made of impregnated fiber;
both sides of the one-piece integrated planar reinforcement structure being respectively integrated with one side of the first insulating layer of the first composite thin film and one side of the second insulating layer of the second composite thin film, so as to form the composite diaphragm of the ribbon type planar speaker made of thermal compression molding;
a first magnet, fixed on an upper frame and disposed above the composite diaphragm; and
a second magnet, disposed below the composite diaphragm and fixed on a lower frame.

15. The structure of ribbon type planar speaker according to claim 14, wherein a first glue layer is disposed between the first insulating layer of the first composite thin film and the one-piece integrated planar reinforcement structure, and a second glue layer is disposed between the second insulating layer of the second composite thin film and the one-piece integrated planar reinforcement structure.

16. The structure of ribbon type planar speaker according to claim 14, wherein a first polymer adhesive layer is disposed between the first conductor circuit and the first insulating layer, and a second polymer adhesive layer is disposed between the second conductor circuit and the second insulating layer.

17. A structure of ribbon type planar speaker, comprising:
a first composite thin film, formed by disposing a first conductor circuit on a first insulating layer;
a second composite thin film, formed by disposing a second conductor circuit on a second insulating layer;
a one-piece integrated planar reinforcement structure, having a flexible edge;
both sides of the one-piece integrated planar reinforcement structure being respectively integrated with one side of the first insulating layer of the first composite thin film and one side of the second insulating layer of the second composite thin film, so as to form the composite diaphragm of the ribbon type planar speaker, wherein the composite diaphragm is of a spatial structure with a deformation region; and
an upper frame and a lower frame, respectively disposed above and below the composite diaphragm, wherein the upper frame and the lower frame have openings.

18. The structure of ribbon type planar speaker according to claim 17, further comprising a first magnet and a second magnet, respectively disposed above and below the composite diaphragm and respectively fixed on the upper frame and the lower frame.

19. The structure of ribbon type planar speaker according to claim 17, further comprising a second lower frame, disposed below the lower frame, wherein an air damping absorption layer is disposed between the lower frame and the second lower frame.

20. The structure of ribbon type planar speaker according to claim 17, wherein a first glue layer is disposed between the first insulating layer of the first composite thin film and the one-piece integrated planar reinforcement structure, and a second glue layer is disposed between the second insulating layer of the second composite thin film and the one-piece integrated planar reinforcement structure.
